(19) United States
(12) Patent Application Publication
(10) Pub. No.: US 2011/0288983 A1
(43) Pub. Date: Nov. 24, 2011

(54) SYSTEM AND METHOD FOR TRADING IN A FINANCIAL MARKET

(75) Inventor: Bradford John Georges, Hawthorn (AU)

(73) Assignee: GREENEYE.COM PTY LTD, Richmond (AU)

(21) Appl. No.: 13/131,569

(22) PCT Filed: Nov. 27, 2009
(86) PCT No.: PCT/AU2009/001551

§ 371 Date: Aug. 15, 2011

(30) Foreign Application Priority Data
Nov. 27, 2008 (AU) 2008906145

(51) Int. Cl. G06Q 40/00

(52) U.S. Cl. 705/37

(57) ABSTRACT

A computer system for executing transactions in a financial market, the system including: (a) a price calculator for calculating blended pricing data from source pricing data received from one or more pricing sources which are independent of any parties to the transaction, the blended pricing data representing a blended bid and blended offer; (b) an automatic transaction processor for automatically executing transactions between a broker-controlled account and an account owned by a predetermined independent market entity based on transaction data generated by a broker-controlled computing apparatus using the blended pricing data; and a pricing data feed handler in communication with the price calculator for transmitting the blended pricing data to the broker-controlled computing apparatus.

### TECHNICAL FIELD

The present invention relates to a system and method for trading in a financial market, such as the foreign exchange market, where at least some traders buy from and sell into the market using a broker.

### BACKGROUND

Many financial markets, such as the stock, commodities or foreign exchange markets, involve trading entities buying and selling an item, instrument or right in the hope that the timing of those trades with fluctuations in the market will result in the generation of a profit.

Such markets have developed entities which assist in maintaining trading flows and liquidity. Each market normally has one or more market makers, who publish bid and offer prices that are maintained through a trading day. This means that anybody who wishes to sell may sell to a market maker at a published rate without needing to locate a buyer. Similarly, anybody wishing to buy from a market maker may do so without locating a seller. The market maker takes each trade on to its “book” (or account) by being the counterparty to each of those trades. The benefits provided by such a system are often outweighed by the unattractive prices typically published by market makers. Market makers alter their spread (the difference between their bid and offer prices) to maximise their profits based on the condition of their book. A trader wishing to participate in the market must therefore shop around for the market entity with the best price, which involves investigating the pricing offered by the market makers in the market, and also the pricing that may be applicable if the trade was with another trader and not a market maker.

Brokers have developed in these markets to facilitate trades for customers. An agency broker operates like an introduction agency, and finds a counterparty to a trade requested by a customer before it executes the trade. For example, if a broker's customer wished to sell at a specific price, the broker would search the market for any entities that would be willing to buy at the nominated price. If the broker cannot find any such entity, no trades are executed. However if the broker identifies a party that is willing to buy at the nominated price, the broker typically organises the sale with the identified party before buying from its customer. In this way, the agency broker is the agent in the middle of the transaction between the customer and the located party. As such trades require the identification of and negotiation with a suitable market entity counterparty before any trade occurs, trading involves a significant amount of delay and uncertainty, and rapid or guaranteed trading cannot occur, reducing trading volumes.

Partly as a solution to this problem, broker-dealers have developed. These broker-dealers will take on to their book their customer's trades, and then look to lay off those trades (execute trades to neutralise its market position) with another market participant. In this way, broker-dealers can execute transactions for their clients quickly, as they take the transactions on to their own book. However, such broker-dealers are unpopular as they are seen to be taking advantage of their less sophisticated clients. In addition, the broker-dealers have very little incentive to offer competitive pricing.

It is desired to provide a system and method for trading in a financial market that alleviates one or more difficulties of the prior art, or at least that provide a useful alternative.

### SUMMARY

According to one aspect of the present invention, there is provided a computer system for executing transactions in a financial market, the system including:
(a) a price calculator for calculating blended pricing data from source pricing data received from one or more pricing sources which are independent of any parties to the transaction, the blended pricing data representing a blended bid and blended offer;
(b) an automatic transaction processor for automatically executing transactions between a broker-controlled account and an account owned by a predetermined independent market entity based on transaction data generated by a broker-controlled computing apparatus using the blended pricing data; and
(c) a pricing data feed handler in communication with the price calculator for transmitting the blended pricing data to the broker-controlled computing apparatus.

The present invention also provides a computer system for executing transactions in a financial market, the system including:
(a) a price calculator for calculating blended pricing data from source pricing data received from one or more pricing sources which are independent of any parties to the transaction, the blended pricing data representing a blended bid and blended offer;
(b) an automatic transaction processor for automatically executing a first transaction between a broker-controlled account and a system account based on transaction data generated by a broker-controlled computing apparatus using the blended pricing data, and automatically executing a second transaction between the system account and an account owned by an independent market entity acting as an offset counterparty to offset the first transaction such that the system account reaches a net zero balance; and
(c) a pricing data feed handler in communication with the price calculator for transmitting the blended pricing data to the broker-controlled computing apparatus.

The present invention also provides a method for automatically executing transactions in a financial market, the method including the steps of:
(a) receiving source pricing data from one or more pricing sources which are independent of any parties to the transaction;
(b) calculating blended pricing data from the source pricing data, the blended pricing data representing a blended bid and blended offer;
(c) sending the blended pricing data to a broker-controlled computing apparatus;
(d) receiving transaction instructions generated by the broker-controlled computing apparatus using the blended pricing data; and
(e) automatically executing a transaction between a broker-controlled account and an account owned by a predetermined independent market entity in accordance with the transaction data generated by the broker-controlled computing apparatus.

The present invention also provides a system having components operative to execute the steps of any one of the above processes.

The present invention also provides a computer-readable storage medium having stored thereon programming instructions for executing the steps of any one of the above processes.

### BRIEF DESCRIPTION OF THE DRAWINGS

Preferred embodiments of the present invention are hereinafter described, by way of example only, with reference to the accompanying drawings, wherein:

FIG. 1 is a block diagram of relevant entities in a financial market including a computer system for trading in a financial market in accordance with one embodiment of the present invention.

FIG. 2 is a flow diagram illustrating a method for trading in a financial market using the system of FIG. 1.

FIG. 3 is a block diagram of the computer system for trading in a financial market as alternatively illustrated in FIG. 1.

### DETAILED DESCRIPTION OF THE PREFERRED EMBODIMENTS

For retail trades in markets such as the foreign exchange market, smaller retail trades (that is, trades from smaller non-professional traders, most often through a broker) result, in the medium-to-long term, in losses for the smaller retail trader. Accordingly, if a single market entity was the counterparty to each of these trades, that single market entity, in the medium-to-long-term, would make a profit.

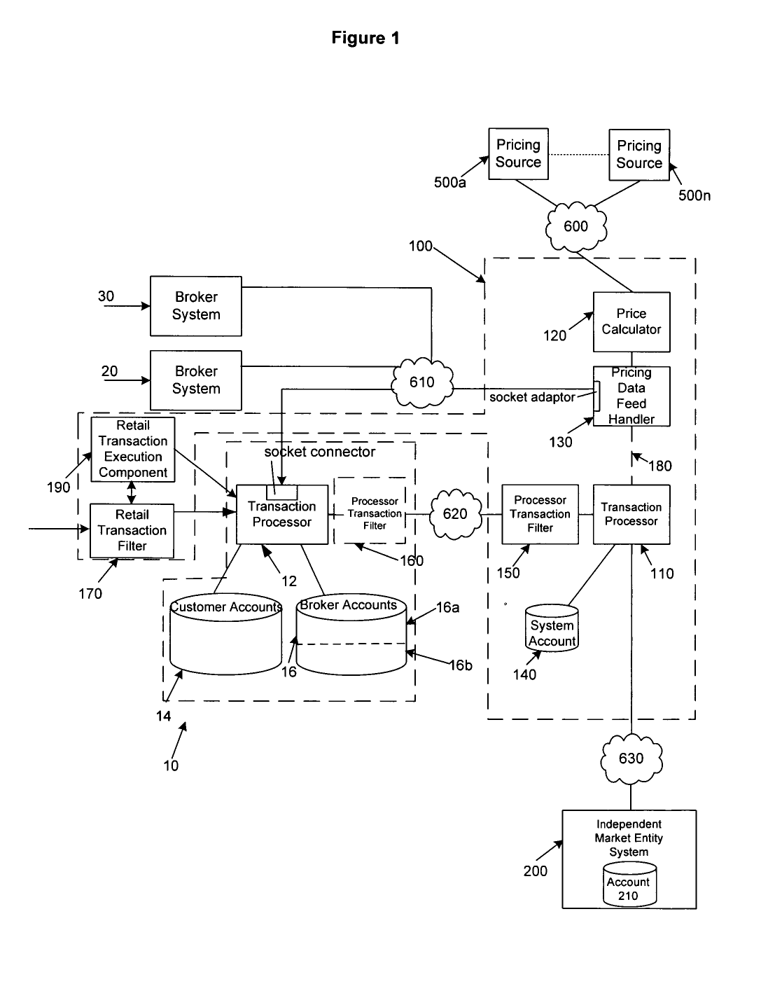

As illustrated in FIG. 1, in one embodiment the present invention takes the form of a computer system 100 which facilitates and encourages trading with a predetermined independent market entity system 200. Retail trades are executed by broker-controlled computer systems 10, 20 and 30. For clarity, only broker-controlled computer system 10 is illustrated in detail.

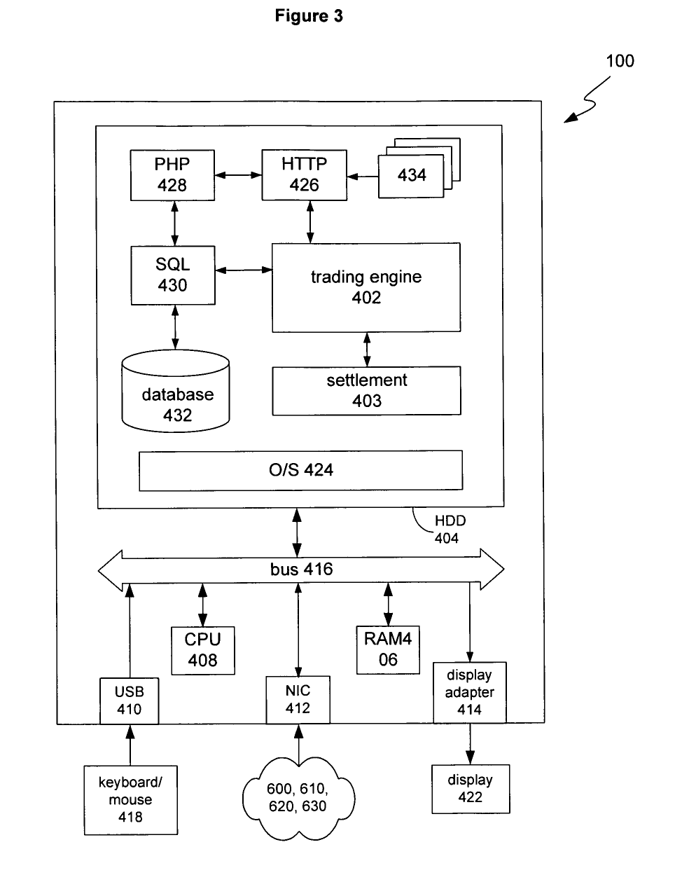

Each of the market participants (including the broker-controlled computer systems 10, 20 and 30, the computer system 100 and the predetermined independent market entity system 200) are computer systems having network interfaces interconnected by one or more communications networks, which may include the Internet. In the described embodiment, the system 100 includes at least one standard computer system such as an Intel IA-32 or IA-64 based computer system or server, as shown in FIG. 3, and the trading processes and functions executed by the system 100 are implemented as programming instructions of one or more software modules 402, 403 stored on non-volatile (e.g., hard disk or solid-state drive) storage 404 associated with the computer system, as shown. However, it will be apparent that at least parts of the trading processes and functions could alternatively be implemented as one or more dedicated hardware components, such as application-specific integrated circuits (ASICs) and/or field programmable gate arrays (FPGAs), for example.

The system 100 includes standard computer components, including random access memory (RAM) 406, at least one processor 408, and external interfaces 410, 412, 414, all interconnected by a bus 416. The external interfaces include universal serial bus (USB) interfaces 410, at least one of which may be connected to a keyboard 418 and a pointing device such as a mouse 419, at least one network interface connector (NIC) 412 which connects the system 400 to the communications network 600, 610, 620 and/or 630, and a display adapter 414, which may be connected to a visual display device such as an LCD panel display 422.

The system 100 also includes a number of standard software modules 426 to 430, including an operating system 424 such as Linux or Microsoft Windows, web server software 426 such as Apache, available at http://www.apache.org, scripting language support 428 such as PHP (available at http://www.php.net) or Microsoft ASP, and structured query language (SQL) support 430 such as MySQL, available from http://www.mysql.com, which allows data to be stored in and retrieved from an SQL database 432.

Together, the web server 426, scripting language module 428, and SQL module 430 provide the system 100 with the general ability to allow other market participants with standard computing devices equipped with standard web browser software to access the system 100 and in particular to provide data to and receive data from the database 432 which implements the optional system account 140 (as described below).

However, it will be understood by those skilled in the art that the specific functionality provided by the system 100 to such users is provided by scripts accessible by the web server 426, including the one or more software modules 402, 403 implementing the trading processes, and also any other supporting scripts and data 434, including markup language (e.g., HTML, XML) scripts, PHP (or ASP), and/or CGI scripts, image files, style sheets, and the like.

For clarity, the market participant computer systems are illustrated in FIG. 1 as including function blocks, which as described above, may be implemented in software stored in non-volatile memory, or in hardware such as ASICs or FPGAs.

Retail customers wishing to trade in a commodity, stock, currency etc. often use a broker to assist with executing those trades. In one embodiment of the present invention, the broker-controlled computer system 10 includes a transaction processor 12 which is configured to “book” each of the customer trades, that is, to be the counterparty to each customer trade. Alternatively, the transaction processor 12 may be configured to book only selected customer trades, for example trades from selected customers, trades below a certain value, or trades that are part of selected trading strategies, the selection of appropriate trades being made by a retail transaction filter 170 as further described below. In a preferred embodiment, the transaction processor 12 is configured to automatically and instantly book all trades falling within predetermined criteria.

The broker controlled computer system 10 includes a customer account database 14 in which customers' account data is stored. It also includes a broker account database 16 which comprises the broker's own account or “book”. In one embodiment, this book comprises a first part 16a, known as an “A-Book”, and a second part, 16b, known as a “B-Book”.

When a customer requests the broker to undertake a trade on its behalf, the broker becomes the counterparty to the trade, and books the trade either in the A-Book or the B-Book. For example, if a customer wishes to sell stock X at $Y, the broker-controlled computer system 10 will modify customer account database 14 to reflect the sale of the stock, and will modify the broker account database 16 to record that the broker has purchased the stock. The broker has therefore taken a position in the market, as it now holds stock X. The trade may be recorded in the A-Book or the B-Book according to the operation of the retail transaction filter 170.

In one embodiment, trades that have a value less than a first threshold amount, and where the client or customer is an individual, are booked in the B-Book. Other trades are booked in the A-Book.

As indicated above, as a result of this trade with the client or customer, the broker has a position in the market. The broker must now find a purchaser for stock X. As described above, agency brokers will not book the trade until they find a purchaser. Agency brokers determine the price for this transaction with a client or customer (known as a retail transaction) relying on the price at which the purchaser is willing to buy the stock. That is, the price for the stock is determined by the broker, relying on counterparties which it is able to identify in the market.

In contrast, in one embodiment of the present invention, the price for the retail trade is not determined by the broker, but instead determined by a price calculator 120 in computer system 110. The price calculator 120 receives source pricing data from one or more pricing sources 500a to 500n that are independent of the broker controlled computing apparatus 10, the independent third party market entity system 200, and the computer system 100. The pricing sources 500 in the preferred embodiment are market makers, but may be any source of valid pricing in the market.

The price calculator 120 receives pricing data from the pricing sources 500 via a communications network 600, which may be a dedicated communication network, or a public network such as the Internet.

The received pricing data would include bid and offer prices for different products, for example, for different stocks in a stock market. The price calculator 120 would therefore receive a bid price and an offer price for a stock from each pricing source 500. From these one or more bid prices and offer prices, the price calculator 120 calculates blended pricing data representing a blended bid and a blended offer.

The blended bid and offer may be calculated as desired to provide an independent price. In one embodiment, the price calculator identifies the highest bid and lowest offer represented in the source pricing data. For example, for stock X, the price calculator may receive pricing data from first pricing source 500a representing a bid of 9401 and an offer of 9405, from a second pricing source 500b representing a bid of 9402 and an offer of 9406, and from a third pricing source 500c representing a bid of 9400 and an offer of 9404. The highest bid from the set {9401, 9402, 9400} is 9402, and the lowest offer from the set {9405, 9406 and 9404} is 9404. The blended bid may simply be the highest received bid (in this case 9402), and the blended offer may be the lowest received offer (9404). Alternatively, the blended bid may be calculated by subtracting a first predetermined margin from the midpoint between the lowest offer and the highest bid. For example, using the figures above, the midpoint between 9404 (lowest offer) and 9402 (highest bid) is 9403. If the predetermined margin is 2, the blended bid is calculated by subtracting 2 from 9403, resulting in a blended bid of 9401. Similarly, the blended offer is calculated by adding 2 to 9403, resulting in a blended offer of 9405.

As an alternative, the price calculator may be configured to calculate the blended bid and offer by modifying the highest and lowest received bid by a second predetermined margin. For example, if the predetermined margin is 1, the blended bid may be calculated by subtracting 1 from the highest bid (in this example, 9402−1=9401), and the blended offer may be calculated by adding 1 to the lowest offer (in this example, 9404+1=9405).

The difference between the bid and the offer is known as the “spread”. One way for a trading entity to make a profit is to maintain a sufficiently wide spread. Accordingly, the price calculator 120 may be configured to maintain a predetermined spread, such that if the spread initially calculated by the price calculator 120 is too low, it is expanded to equal the predetermined spread. Using the current example, the predetermined spread may be 6. The spread as initially calculated by the price calculator 120 is 9505−9401=4. In other words, the difference between the blended offer and blended bid is less than the predetermined spread. Accordingly, the price calculator 120 may be configured to increase this difference to equal the predetermined spread of 6. It does this by widening the spread by 2, decreasing the blended bid by 1 and increasing the blended offer by 1.

A pricing data feed handler 130 in communication with the price calculator 120 publishes the blended price data to the transaction processor 12 of the broker-controlled computing apparatus 10 and optionally the transaction processor 110 of the computer system 100. The pricing data feed handler 130 may comprise a software program in communication with a network interface, which is in turn connected to a network 610 to which the broker-controlled computing apparatus is connected. Communication network 610 may be the same as communication network 600, and is preferably a wide area network such as the Internet. The pricing feed data feed handler 130 may communicate with the transaction processor 12 of the broker-controlled computing apparatus using standard TCP/IP protocols and using socket connections as known in the art. A “heartbeat” (as also known in the art) may be used to monitor the status of the connection.

The broker-controlled computing apparatus 10 uses the blended price data to book retail customer transactions. In this way, the broker is independent of the pricing of the trade, and, by virtue of the operation of the price calculator 120, can be assured of obtaining prices that are at least very competitive.

Where the broker uses an A-Book and a B-Book according to criteria determined by the retail transaction filter 170, the blended pricing data can be selectively applied to either the A-Book or the B-Book. For example, all B-Book trades may be executed by the transaction processor 12 of the broker-controlled computing apparatus 10 using the blended pricing data received from the pricing data feed handler 130.

The computer system 100 optionally includes a retail transaction execution component 190 for instructing the broker-controlled computing apparatus 10 (more specifically, its transaction processor 12) to automatically execute retail transactions immediately upon request by the retail customer at a price based on the blended pricing data. The retail transaction execution component 190 is in communication with the retail transaction filter 170, such that only selected trades are automatically executed by the transaction processor 12 of the broker-controlled computing apparatus.

The price of the retail trade uses, or is based upon, the blended pricing data, but the retail trade need not be executed at the blended offer or blended bid. A broker may broaden the spread of the blended offer and blended bid so as to improve its profits on the transaction. In some markets this is known as “pipping”.

By automatically and immediately executing retail trades that are selected by the retail transaction filter 170, broker workload is reduced and the broker's clients enjoy responsive, immediate trading, facilitating greater trading volumes.

In one embodiment of the present invention, the booking of the trade by the broker-controlled computing apparatus 10 using the blended price data results in the transaction processor 12 of broker-controlled computing apparatus 10 sending transaction data to a transaction processor 110 in computer system 100. The transaction data is sent through network 620, which may be the same network as networks 600 and 610, and is preferably a wide area network such as the Internet.

The transaction data may include an identification of the stock, whether the broker bought or sold the stock to its customer, the volume of stock traded, information about the retail customer and optionally the price of the trade. Based on that transaction data, the transaction processor 110 of computer system 100 executes a trade between the broker-controlled account held in database 16 and a predetermined independent market entity-controlled account 210 (stored in a database of predetermined independent market entity system 200), the result of which is that the broker lays off the transaction to the predetermined independent market entity and thereby maintains a neutral position. Where the price of the trade is not part of the transaction data, that data may be obtained by the transaction processor 110 directly from the pricing data feed 130 using communications link 180 (as illustrated in FIG. 1 with a dashed line).

The independent market entity system 200 is in communication with the computer system 100 through a communications network 630, which may be the same network as networks 600, 610 and 620, or may be a private network or communications link.

In the example above, the broker purchased stock X at prices published by the pricing data feed handler 130, the result of which is that the broker-controlled computing apparatus 10 books a retail customer trade into its B-Book in portion 16b of the broker account database 16. Transaction data describing this transaction is sent to the transaction processor 110 of the computer system 100, which executes a sale transaction between the broker-controlled account in portion 16b of the broker account database, and predetermined independent market entity-controlled account 210.

As described above, the transaction processor 110 of computer system 100 may execute a transaction between the broker-controlled computing apparatus 10 and the predetermined independent market entity system 200. Alternatively, the computer system 100 may be configured to use its system account 140 as an intermediate trading entity. In this configuration, the transaction processor 110 is configured to execute a first transaction between a broker-controlled account stored in 16b and a system account 140 based on the transaction data generated by the transaction processor 12 of the broker-controlled computing apparatus 10. The transaction processor 110 is also configured to automatically execute a second transaction between the system account 140 and the account 210 owned by the independent market entity, which acts as an offset counterparty to offset the first transaction. Put another way, the broker sells stock X to the computer system 100, which on-sells the stock to the independent market entity. Depending on the regulations governing the financial market, a prime broker entity may be required to operate the system 100 so as to enable system 100 to participate in trades.

By executing the second offsetting transaction, the system account 140 reaches a net zero balance. The system account 140 only temporarily owns stock X, and the funds it used to purchase stock X from the broker are recouped as a result of the offsetting transaction, which is executed at the same price and using pricing data in the transaction data generated by transaction processor 12, or sent to the transaction processor 110 by the pricing data feed handler 130 using communications link 180.

As described above, it may be desirable to only have selected trades result in the transaction processor 110 executing trades between the broker-controlled account 16 and the account 210 of an independent market entity system 200 (possibly with a system account 140 acting as a temporary intermediary as described above). Accordingly, the system 100 may include a retail transaction filter 170, which may operate to classify retail transactions (transaction between a broker and its retail clients) into transactions to be booked using the A-Book, and transactions to be booked using the B-Book, with all B-Book transactions resulting in the generation of transaction data which results in an offsetting trade with the independent market entity system 200. Alternatively, the broker-controlled computing apparatus 10 may generate transaction data for all retail trades, and a processor transaction filter 150 may operate on that generated data to ensure that only selected filtered transaction data is used by the transaction processor 110. Processor transaction filter 150 it may be physically located at either the broker site (as shown in dotted outline 160 in FIG. 1) or the system site (as shown in solid outline 150 in FIG. 1), as it will be apparent to one skilled in the art that its physical location does not affect its filtering function.

The processor transaction filter 150 and retail transaction FIG. 170 may be configured to select transaction data that relates to transactions having a value less than a first threshold amount. Larger, professional traders and hedge traders tend to have high-value trades, and these trades have a lower probability of being profitable for the independent market entity in the medium to long term. Alternatively or additionally, the processor transaction filter 150 and retail transaction filter 170 may be configured to select transaction data that is derived from data representing retail transactions between the broker and retail customers having predetermined characteristics. For example, only transactions with retail customers having an average of fewer than 10 trades a month may be booked and subsequently offset with the independent market entity.

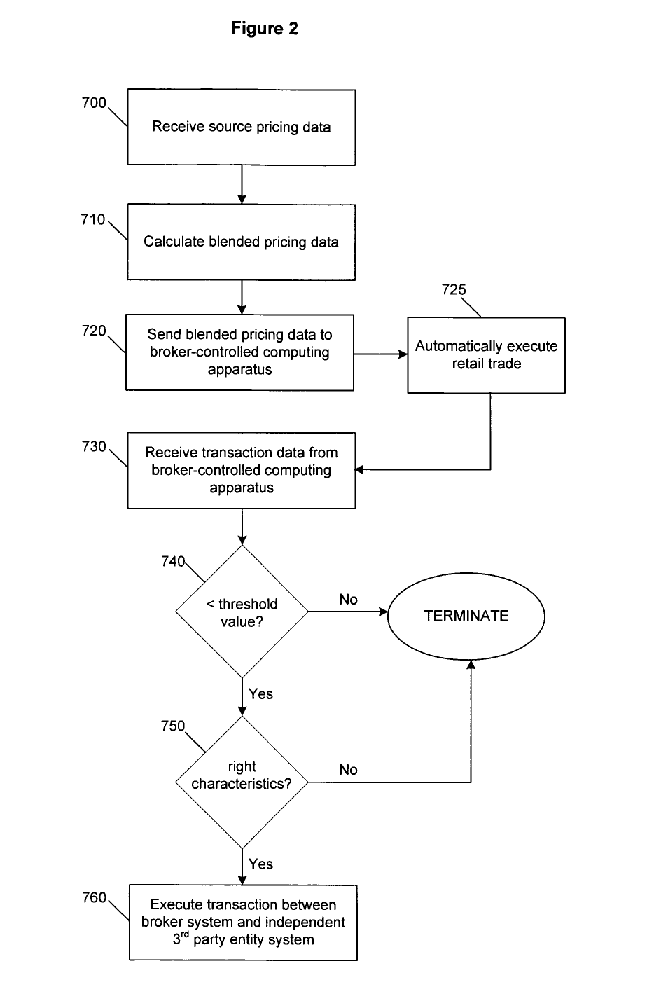

A preferred embodiment of a method for automatically executing transactions in a financial market will now be described with reference to FIG. 2.

In step 700, the price calculator 120 of system 100 receives source pricing data from one or more pricing sources 500 which are independent of any parties to the transaction. The price calculator 120 of system 100 then calculates blended pricing data from the source pricing data as further described above (step 710), the blended pricing data representing a blended bid and a blended offer. In step 720, the price calculator 120 of system 100 then sends the blended pricing data to a broker-controlled computing apparatus 10 (which, as described above, may be an appropriately programmed general purpose computer).

At step 725, the retail transaction execution component 190 instructs the transaction processor 12 to automatically execute the retail transaction between the broker and its retail customer at a price based on the blended pricing data.

The system 100 then receives transaction data generated by the broker-controlled computing apparatus 10 (step 730). If the transaction data is for a value less than a threshold, the process continues, otherwise an error message is sent to the broker-controlled computing apparatus 10 and the process terminates (step 740). In step 750, a determination is made as to whether the retail customer has the right characteristics (eg trading pattern, size etc). If the retail customer does not have the right characteristics, an error message is sent to the broker controlled computing apparatus 10 and the process terminates. In step 760, the transaction processor 110 of the system 100 automatically executes a transaction between a broker-controlled account 16 and an account owned by a predetermined independent market entity 200 based on transaction data generated by the broker-controlled computing apparatus.

The system 100 thus provides many advantages to the market in which it operates. It provides brokers with the ability to execute trades automatically and instantaneously using the best, or nearly the best, prices in the market, set independently of the broker (thereby avoiding any suggestion that the broker has an interest in the trade), thereby increasing customer satisfaction. The broker can enable this automatic and instantaneous trade by booking each trade, and can do so without taking on any market risk as it is assured that it can lay-off (or offset) the trade with an independent third party market entity. This increases the broker's transaction volume, thereby increasing the broker's profits and bringing greater liquidity to the market (due to the higher trade volume). The third party market entity, which may be funded by a syndicate or collective), is effectively the ultimate counterparty to each retail trade (subject to trade data filtration as discussed above), and therefore will generate a profit in the mid- to long-term. Brokers may have a financial (but not controlling) interest in the third party market entity, providing them with the benefit of the trades without compromising their integrity.

Although embodiments of the present invention have been described above largely in the context of a stock market, it will be apparent to those skilled in the art that the invention can equally be applied to other financial markets, such as foreign exchange markets, for example.

Many modifications will be apparent to those skilled in the art without departing from the scope of the present invention as hereinbefore described with reference to the accompanying drawings.

1. A computer system for executing transactions in a financial market, the system including:
(a) a price calculator for calculating blended pricing data from source pricing data received from one or more pricing sources which are independent of any parties to the transaction, the blended pricing data representing a blended bid and blended offer;
(b) an automatic transaction processor for automatically executing transactions between a broker-controlled account and an account owned by a predetermined independent market entity based on transaction data generated by a broker-controlled computing apparatus using the blended pricing data; and
(c) a pricing data feed handler in communication with the price calculator for transmitting the blended pricing data to the broker-controlled computing apparatus.

2. A computer system as claimed in claim 1 wherein the computer system is configured to receive from the broker-controlled computing apparatus transaction data derived from data representing at least one retail transaction between the broker and a retail customer.

3. A computer system as claimed in claim 2 further including a retail transaction execution component for instructing the broker-controlled computing apparatus to execute the retail transaction immediately upon request by the retail customer at a price based on the blended pricing data.

4. A computer system as claimed in claim 1 further including a processor transaction filter for selecting filtered transaction data from transaction data generated by the broker-controlled computing apparatus, the automatic transaction processor only processing filtered transaction data.

5. A computer system as claimed in claim 4 wherein the processor transaction filter is configured to select transaction data that relates to transactions having a value less than a first threshold amount.

6. A computer system as claimed in claim 4 wherein the processor transaction filter is configured to select transaction data derived from data representing retail transactions between the broker and retail customers having predetermined characteristics.

7. A computer system as claimed in claim 1 further including a retail transaction filter in the broker-controlled computing apparatus for selecting the retail transactions from which transaction data is derived.

8. A computer system as claimed in claim 7 wherein the retail transaction filter is configured to select retail transactions having a value less than a first threshold amount.

9. A computer system as claimed in claim 7 wherein the retail transaction filter is configured to select retail transactions between the broker and retail customers having predetermined characteristics.

10. A computer system as claimed in claim 1 wherein the price calculator is configured to identify the highest bid and lowest offer represented in the source pricing data.

11. A computer system as claimed in claim 10 wherein the price calculator is configured to calculate the blended bid by subtracting a first predetermined margin from the midpoint between the lowest offer and the highest bid, and calculate the blended offer by adding the first predetermined margin to the midpoint between the lowest offer and the highest bid.

12. A computer system as claimed in claim 10 wherein the price calculator is configured to calculate the blended bid by subtracting a second predetermined margin from the highest bid, and calculate the blended offer by adding the second predetermined margin to the lowest offer.

13. A computer system as claimed in claim 11 wherein the price calculator is configured to increase the difference between the blended offer and blended bid to a predetermined spread if the difference is less than the predetermined spread.

14. A computer system for executing transactions in a financial market, the system including:
(a) a price calculator for calculating blended pricing data from source pricing data received from one or more pricing sources which are independent of any parties to the transaction, the blended pricing data representing a blended bid and blended offer;
(b) an automatic transaction processor for automatically executing a first transaction between a broker-controlled account and a system account based on transaction data generated by a broker-controlled computing apparatus using the blended pricing data, and automatically executing a second transaction between the system account and an account owned by an independent market entity acting as an offset counterparty to offset the first transaction such that the system account reaches a net zero balance; and
(c) a pricing data feed handler in communication with the price calculator for transmitting the blended pricing data to the broker-controlled computing apparatus.

15. A computer system as claimed in claim 14 wherein the computer system is configured to receive from the broker-controlled computing apparatus transaction data derived from data representing at least one retail transaction between the broker and a retail customer.

16. A computer system as claimed in claim 15 further including a retail transaction execution component for instructing the broker-controlled computing apparatus to execute the retail transaction immediately upon request by the retail customer at a price based on the blended pricing data.

17. A computer system as claimed in claim 14 further including a processor transaction filter for selecting filtered transaction data from transaction data generated by the broker-controlled computing apparatus, the automatic transaction processor only processing filtered transaction data.

18. A computer system as claimed in claim 17 wherein the processor transaction filter is configured to select transaction data that relates to transactions having a value less than a first threshold amount.

19. A computer system as claimed in claim 17 wherein the processor transaction filter is configured to select transaction data derived from data representing retail transactions between the broker and retail customers having predetermined characteristics.

20. A computer system as claimed in claim 14 further including a retail transaction filter in the broker-controlled computing apparatus for selecting the retail transactions from which transaction data is derived.

21. A computer system as claimed in claim 20 wherein the retail transaction filter is configured to select retail transactions having a value less than a first threshold amount.

22. A computer system as claimed in claim 20 wherein the retail transaction filter is configured to select retail transactions between the broker and retail customers having predetermined characteristics.

23. A computer system as claimed in claim 14 wherein the price calculator is configured to identify the highest bid and lowest offer represented in the source pricing data.

24. A computer system as claimed in claim 23 wherein the price calculator is configured to calculate the blended bid by subtracting a first predetermined margin from the midpoint between the lowest offer and the highest bid, and calculate the blended offer by adding the first predetermined margin to the midpoint between the lowest offer and the highest bid.

25. A computer system as claimed in claim 23 wherein the price calculator is configured to calculate the blended bid by subtracting a second predetermined margin from the highest bid, and calculate the blended offer by adding the second predetermined margin to the lowest offer.

26. A computer system as claimed in claim 24 wherein the price calculator is configured to increase the difference between the blended offer and blended bid to a predetermined spread if the difference is less than the predetermined spread.

27. A method for automatically executing transactions in a financial market, the method including:
receiving source pricing data from one or more pricing sources which are independent of any parties to the transaction;
calculating blended pricing data from the source pricing data, the blended pricing data representing a blended bid and blended offer;
sending the blended pricing data to a broker-controlled computing apparatus;
receiving transaction instructions generated by the broker-controlled computing apparatus using the blended pricing data; and
automatically executing a transaction between a broker-controlled account and an account owned by a predetermined independent market entity in accordance with the transaction data generated by the broker-controlled computing apparatus.

28. A method as claimed in claim 27 wherein receiving transaction data includes receiving transaction data derived from data representing transactions between the broker and its retail customer.

29. A method as claimed in claim 28 further including automatically executing the transaction between the broker and its retail customer immediately upon request by the retail customer at a price based on the blended pricing data.

30. A method as claimed in claim 27 wherein automatically executing a transaction includes executing a transaction between a broker-controlled account and an account owned by a predetermined independent market entity through one or more intermediaries.

31. A method as claimed in claim 27 further including:
selecting filtered transaction instructions from the received transaction data; and
automatically executing only the filtered transaction data.

32. A method as claimed in claim 31 wherein selecting filtered transaction instructions includes selecting only transaction data that relate to transactions having a value less than a first threshold amount.

33. A method as claimed in claim 31 wherein selecting filtered transaction instructions includes selecting only transactions data derived from data representing retail transactions between the broker and retail customers having predetermined characteristics.

34. A method as claimed in claim 27 wherein calculating blended price data includes identifying the highest bid and lowest offer represented in the source pricing data.

35. A method as claimed in claim 34 wherein calculating blended price data further includes:
subtracting a first predetermined margin from the midpoint between the lowest offer and the highest bid to calculate the blended bid; and
adding the first predetermined margin to the midpoint between the lowest offer and the highest bid to calculate the blended offer.

36. A method as claimed in claim 34 wherein calculating the blended price data includes:
subtracting a second predetermined margin from the highest bid to calculate the blended bid; and
adding the second predetermined margin to the lowest offer to calculate the blended offer.

37. A method as claimed in claim 35 further including increasing the difference between the blended offer and the blended bid to a predetermined spread if the difference is less than the predetermined spread.

38. (canceled)

39. A non-transitory computer-readable storage medium having stored thereon programming instructions for executing the steps of claim 27.
